(19) United States
(12) Patent Application Publication
(10) Pub. No.: US 2008/0299286 A1
(43) Pub. Date: Dec. 4, 2008

(54) PALATABILITY ENHANCING COMPOSITIONS AND FOODS FOR PETS, AND METHODS REGARDING THE SAME

(76) Inventors: David B Josephson, Lebanon, OH (US); Daniel L. Gallagher, Silverton, OR (US)

Correspondence Address: DINSMORE & SHOHL, LLP, 1900 CHEMED CENTER, 255 EAST FIFTH STREET, CINCINNATI, OH, 45202, US

(21) Appl. No.: 12/131,543

(22) Filed: Jun. 2, 2008

Related U.S. Application Data
(60) Provisional application No. 60/941,930, filed on Jun. 4, 2007.

(51) Int. Cl. A23K 1/16

(52) U.S. Cl. 426/650

(57) ABSTRACT

Palatability enhancing compositions for pet foods, and pet foods with increased palatability, are provided. In some embodiments, the compositions and pet foods contain tea, such as green tea. In some embodiments, the compositions and pet foods contain brewer's yeast, liver hydrolysate, phosphate, and green tea. Shrimp meal and Tuna meal can also be utilized in these embodiments. In some embodiments, the compositions and pet foods comprise an ingredient having at least one of theanine; glutamine; tea; 1,5 octadien-3 one; 1,5-octadien-3-ol; and Camellia sinensis plant. In one example, green tea is used in a pet food palatability enhancing system at 0.1-25%, 1-15%, or 2-9% by weight of the system, and at 0.025-0.5% or 0.01 to 1.0% by weight of the pet food.

### CROSS REFERENCE TO RELATED APPLICATIONS

This application claims the benefit of U.S. Provisional Application Ser. No. 60/941,930 filed Jun. 4, 2007, the entire disclosure of which is hereby incorporated by reference.

### TECHNICAL FIELD

This invention relates generally to pet food compositions with enhanced palatability, and to methods regarding the same. In one embodiment, dry or liquid flavor compositions or coatings for pet foods are provided that can provide increased palatability at low application levels.

### BACKGROUND

The makers of animal food have a long-standing desire to provide pet food having high nutritional value, and favorable palatability, along with low production costs and low application levels of coatings or flavor additives. The first category of pet food is canned or high moisture content products (greater than 70% moisture), which are typically high meat-containing products, and are generally more palatable than other product forms. The second category is dry, extruded or low moisture content products (less than 15% moisture), which have the least expensive packaging, greatest convenience, but are generally less palatable than canned product forms. The third category is semi-dry or intermediate moisture content products (about 15-50% moisture). Semi-dry products are generally less palatable than canned food, but generally more palatable than dry food.

Many animals, particularly cats, are finicky eaters, and require a high degree of palatability in products they consume. There is a continuing need, therefore, to produce more palatable pet food, particularly for application to dry, extruded product forms although principles of the invention can be applied to all product forms mentioned above.

Some palatability systems for pet foods and/or pet foods with increased palatability have been developed. However, many systems have suffered from lower than desired palatability results and/or high manufacturing costs. Moreover, while a variety of ingredients have been utilized in pet foods for therapeutic or general health purposes, such ingredients have not been considered as palatability enhancing systems and/or been provided in combinations with ingredients or at levels that provide satisfactory cost and enhanced palatability characteristics. Additionally, some such systems and foods have had aromas that are not attractive to the pet owner.

Accordingly, improved pet food flavoring compositions for pet foods are desired that are efficacious and cost effective.

### SUMMARY

Palatability enhancing compositions for pet foods, and pet foods with increased palatability, are provided. In some embodiments, the palatability enhancing compositions and pet foods contain tea, such as green tea. In some embodiments, the compositions and pet foods contain brewer's yeast, liver hydrolysate, phosphate, and green tea. Shrimp meal can also be utilized in these embodiments. Tuna meal can also be utilized in these embodiments. In some embodiments, the compositions and pet foods comprise an ingredient having at least one of theanine; glutamine; tea; 1,5 octadien-3 one; 1,5-octadien-3-ol; and Camellia sinensis plant. In one example, green tea is used in a pet food palatability enhancing system at 0.01-25%, by weight of the system.

### DETAILED DESCRIPTION

Compositions according to one embodiment of the present invention comprise both liquid and dry pet food flavor or coating compositions that provide high palatability at low application levels. Palatability enhancer compositions in accordance with this embodiment include green tea, such as, for example, at 0.01-25% by weight of the flavor/coating (or 1-15% and or 2-9%), and at 0.01-1.0% (or 0.025-0.5%) of the final pet food product, and exhibit excellent flow properties, while providing both flavor and chemoattractive aroma in a single composition. Additionally, this embodiment comprises a dry combination that significantly beats a dry palatability system devoid of green tea solids and/or extractives. These palatability enhancers may be used with or without flavors.

According to another embodiment, a flavor composition is provided as a palatability system containing green tea, a hydrolyzed liver or other protein source, dried brewers yeast, and a single acid or combinations thereof. The composition may include at least one organic acid, and/or amino acid(s). The green tea may be applied in this embodiment at, for example, 0.01-25% by weight of the flavor/coating (or 1-15% and or 2-9%), and at 0.01-1.0% (or 0.025-0.5%) by weight of the final pet food product.

In accordance with another embodiment, a composition is provided as a palatability system containing green tea, a hydrolyzed liver or other protein source, brewers yeast, and a phosphate or phosphate salt (such as trisodium pyrophosphate or disodium phosphate for example). The green tea may be applied in this embodiment at, for example, 0.01-25% by weight of the palatability system (or 1-15% or 2-9%), and at 0.01-1.0% (or 0.025-0.5%) by weight of the final pet food product. Such an embodiment can provide significantly increased palatability enhancement at good cost.

According to another embodiment, a composition is provided as a palatability system containing green tea and shrimp meal. The green tea may be applied in this embodiment at, for example, 0.01-25% by weight of the palatability system (or at 1-15% and or at 2-9%), and at 0.01-1.0% (or 0.025-0.5%) by weight of the final pet food product. The shrimp meal may be applied at 0.01-10% by weight of the palatability system. The shrimp may be a thermally processed shrimp.

In accordance with another embodiment, a composition is provided as a palatability system containing green tea and an organic and/or an inorganic acid. The green tea may be applied in this embodiment at, for example, 0.01-25% by weight of the palatability system (or at 1-15% or at 2-9%), and at 0.01-1.0% (or 0.025-0.5%) by weight of the final pet food product. The organic and/or inorganic acid may constitute 0.01-50% of the palatability system.

In accordance with another embodiment, a composition is provided as a palatability system containing a substance having theanine or glutamine, or analogs of the same. The substance may be applied in this embodiment at, for example, 0.01-25% by weight of the palatability system (or at 1-15% and or at 2-9%), and at 0.01-1.0% (or 0.025-0.5%) by weight of the final pet food product.

According to another embodiment, a composition is provided as a palatability system containing a substance having an extract, distillate, or portion of a tea or Camellia sinensis plant. The substance may be applied in this embodiment at, for example, 0.01-25% by weight of the palatability system (or at 1-15% and or at 2-9%), and at 0.01-1.0% (or 0.025-0.5%) by weight of the final pet food product.

According to another embodiment, a pet food or palatability system for the same is provided comprising tea and having a humanization ingredient or composition. The ingredient or composition can provide an aroma like human table fare. The human table fare can comprise steak, filet mignon, porterhouse, top sirloin, New York strip, stewed beef, rotisserie chicken, roast chicken, grilled chicken, white fish flesh, and the like.

In accordance with another embodiment, a composition is provided as a palatability system containing a substance having 1,5-octadien-3 one. The substance may be applied in this embodiment at 0.00000001-2.0% by weight of the palatability system (or at 0.00000001-0.01% and or at 0.000000°-0.0001%), and at 0.00000001-0.005% by weight of the final pet food product, for example.

According to another embodiment, a composition is provided as a chemoattractant containing green tea. The green tea may be applied in this embodiment at 0.01-25% by weight of the chemoattractant composition (or at 1-15% and or at 2-9%), and at 0.01-1.0% (or 0.025-0.5%) by weight of the final pet food product, for example.

Such palatability enhancers described herein can be applied, for example, as a coating or layer applied onto the surface of a basal pet food composition. The palatability enhancers may also be incorporated into a pet food composition. The enhancers may include meat-type flavorings, derived from chicken, pork or beef liver and/or chicken or pork viscera.

Green tea, as used herein, can include steam-cured green tea, fire-cured green tea, or green tea processed by non-traditional methods, like roasting or drying in a tumble drier, vacuum drier, extruder, and the like. The green tea can be steam-cured or fire-cured green tea for example, and can comprise about 0.05% to about 98% by weight of the flavor composition and 0.01% to about 2.5% by weight of the pet food composition, for example. The green tea can be provided as an extract or as a distillate, in the embodiments herein, such as at about 0.01-15% by weight of the system for example. Thus, the green tea may comprise at least one of fire-cured green tea, steam-cured green tea, extruded green tea, tumble roasted green tea, and processed green tea using open or closed heating sources. Other teas are also possible for the embodiments herein, in addition to or as alternatives to green tea, such as portions or distillates or extracts from black tea, white tea, oolong tea, other Camellia Sinensis plants, portions thereof, and the like.

In addition, different green teas can be used depending on the desired attribute. A steam-cured green tea can be provided with a clean roasted seafood-like profile while a fire-cured green tea can be provided with smoky, roasted, herbal notes.

The palatability system/composition can be applied to or mixed with a basal composition. Basal composition, as used herein, refers to the pet food (e.g., dry pet food, wet pet food, pet treats and the like) to which the palatability enhancer or flavor composition is added. The basal composition can include at least one of the following: poultry or beef by-products; vegetable protein meals; animal proteins; animal tissue or meals; grains, such as corn, milo, alfalfa, wheat, soy, and the like; carbohydrates; fat, e.g., tallow; minerals; vitamins; and preservatives, for example. However, any of a variety of pet food ingredients may be utilized. For example, basal compositions that are commercially sold and that are nutritionally balanced can be utilized. The pet food is typically in bite size or pellet form of any shape.

Coating, as used herein, refers to the topical deposition of the palatability enhancer or flavor composition to the surface of the basal composition, such as by spraying, dusting, and the like. The flavor composition may be applied to the kibble before, after, or as part of a fat coating. The flavor composition may be applied to the kibble in a uniform manner.

In one embodiment, dry or liquid green tea is used as a coating for dry pet food in combination with a flavor. As shown in the examples below, the application of green tea and a flavor is superior to an equivalent amount of palatant alone.

Another embodiment of the invention includes the use of liquid or dry green tea as a coating for pet food, with or without the inclusion of a flavor, but in combination with an organic acid. According to this embodiment, green tea comprises about 0.05% to about 2.0%, and preferably 0.5% to about 1.0%, by weight of the pet food, and the organic acid comprises about 0.01% to about 2.0%, and preferably about 1.0%, by weight of the pet food. The Examples below show that a combination of liquid or dry green tea, with or without flavor, is superior to a traditional palatability system and flavor, a traditional palatability system alone.

Another embodiment of the invention includes the use of dry or liquid green tea as a coating for dry pet food in combination with a dry or liquid flavor. As shown in the Examples, the application of green tea and a flavor can be superior to a flavor alone.

### Method for Coating Pet Food:

In one embodiment, kibbles, for example, uncoated extruded basal cat food obtained from a pet food manufacturer, are placed in a convenient container for mixing, such as a small cement mixer, tub or coating drum. A fat, such as lard or beef tallow, is heated to about 130 degrees Fahrenheit and sprayed onto the cat food in any convenient manner to obtain a coating of the kibbles. The coating need not be a continuous layer yet any reasonable sample preferably exhibits a uniformity of coating. The cat food is mixed during and for a few minutes after spraying the fat to improve uniformity of the coating, although a uniform coating is not required. After the fat is applied, it cools quickly and acts as an imperfect barrier to other compounds that are applied following fat coating. At this point a flavor composition/palatability enhancer system may be applied as either a dry powder or a liquid. Alternatively, a flavor composition/palatability enhancer could be mixed with the fat and applied concurrently.

Two embodiments of palatability systems are provided as follows, the percentages being shown by dried weight. Many other embodiments are possible.

| Item | Formula 1 |
|---|---|
| Dried whey | 30 |
| Trisodium | 25 |
| Pyrophosphate | |
| Hydrolyzed Chicken | 20 |
| Liver | |
| Brewers Yeast | 15 |
| Green Tea | 7 |
| Shrimp meal | 2 |
| Sodium | 1 |
| Hexametaphosphate | |
| | 100 |

| Item | Formula 2 |
|---|---|
| Brewers yeast | 40 |
| Hydrolyzed Chicken | 25 |
| Liver | |
| Disodium phosphate | 15 |
| Green Tea | 9 |
| Sodium | 8.25 |
| Hexametaphosphate | |
| Shrimp meal | 2 |
| Citric acid | 0.75 |
| | 100 |

In order that embodiments of the invention may be more fully understood, the following examples of test data are provided, but are for illustrative purposes only and are not to be construed as limiting the inventions in any manner.

The test data tabulated in the examples is derived from the industry standard two bowl comparison. Each animal is presented with two bowls of food, each containing a measured amount of one of the test rations. The amount of food eaten is measured. A direct comparison of two rations gives a reliable indication of relative palatability.

For these tests, twenty cats are fed for two days to give a total of forty choices. An independent cattery is used. The bowl position is changed daily to eliminate animals that show a preference for right or left placement of the bowls. The cumulative amounts of the two rations are used to calculate the consumption ratio (C.R.). The ration with more eaten is divided by the ration with less eaten to give a positive ratio. For example, a C.R. of 2 means that twice as much of one ration is eaten as compared to the other ration. Palatability tests were performed in order to demonstrate and quantify the palatability enhancement effects provided by various compositions, and/or the willingness, excitement or eagerness of a pet to approach a food and consume it.

The formulations for the examples are provided below. The numbers shown are percentages by weight.

| | | | | | | | | | |
|---|---|---|---|---|---|---|---|---|---|
| | | | | | 3.6D- | 3.6D- | 3.6D- | 3.6D- | 3.6D- |
| | 3.6D- | | 3.6D- | 3.6D- | RS + 1 | RS + 2 | RS + 3 | TG | NTG |
| 3.6D | GT | 3.6D-T | RS+ | RS++ | tea 1 | tea 2 | tea 3 | with | without |

Item

| | | | | | | | | | | |
|---|---|---|---|---|---|---|---|---|---|---|
| Hydrolyzed Chicken Liver | 30-50 | 30-50 | 30-50 | 30-50 | 30-50 | 30-50 | 30-50 | 30-50 | 30-50 | 30-50 |
| Trisodium Pyrophosphate | 30-50 | 30-50 | 30-50 | 30-50 | 30-50 | 30-50 | 30-50 | 30-50 | 5-15 | 5-15 |
| Brewers Yeast | 5-15 | 5-15 | 5-15 | 5-15 | 5-15 | 5-15 | 5-15 | 5-15 | 15-30 | 15-30 |
| Dried Whey | 5-15 | 5-15 | 5-15 | 5-15 | 5-15 | 5-15 | 5-15 | 5-15 | 5-15 | 5-15 |
| Shrimp Meal | 0 | 0 | 0 | 0.5-5 | 5-15 | 0.5-5 | 0.5-5 | 0.5-5 | 0.5-5 | 0.5-5 |
| Tuna Meal | 0 | 0 | 0.5-5 | 0 | 0 | 0 | 0 | 0 | 0 | 0 |
| Green Tea (stnd) | 0 | 0.5-5 | 0.5-5 | 0.5-5 | 0.5-15 | 0 | 0 | 0 | 7 | 0 |
| Green Tea (11724) steam-fired | 0 | 0 | 0 | 0 | 0 | 0.5-5 | 0 | 0 | 0 | 0 |
| Green Tea (20035) steam-fired | 0 | 0 | 0 | 0 | 0 | 0 | 0.5-5 | 0 | 0 | 0 |
| Green Tea (30005) flue-fired | 0 | 0 | 0 | 0 | 0 | 0 | 0 | 0.5-5 | 0 | 0 |
| Maltodextrin | 0 | 0 | 0 | 0 | 0 | 0 | 0 | 0 | 0 | 7 |
| | 100 | 100 | 100 | 100 | 100 | 100 | 100 | 100 | 100 | 100 |

GT = Green Tea
T = Tuna
RS = Roast Shrimp
TG-Green Tea
NTG = No Green Tea

### EXAMPLE 1

The objective is to determine if one product's palatability is equal to or preferred to another when offered to a panel of cats. The two cat diets are identified as:

Diet A: MBG003.6D CONTROL

Diet B: MARKET LEADING CAT KIBBLE CONTROL

A panel of 21 group-housed cats is used for the trial. The panel receives the test diets in two large bowls labeled “A” and two large bowls labeled “B”. The bowls are randomly placed each day into four radio frequency monitored feeding stations at 4:45 p.m. and removed at 7:15 a.m. the next morning for a total feeding time of 14.5 hours.

A radio frequency (RFID) system records First Choice, First Approached, and Meal Event Consumption Data for each member of the panel throughout the test period and transfers the information to a data collection computer. (The cats collars include RFID tags which are picked up by sensors). At the conclusion of the test, calculations and statistical analysis were performed by Preference Technology Inc., incorporated herein by reference.

Fresh, clean reverse osmosis water is available for the cats at all times. The procedure is carried out for 2 days. The following parameters are measured and recorded for each animal:

Amount of diet consumed daily

Diet first approached

Diet first tasted

Animal intake by hour and by day

Weight of the animal

Out of a total of 42 tastes, MBG003.6D CONTROL is first tasted 23 times and MARKET LEADING CAT KIBBLE CONTROL is first tasted 19 times for a ratio of 1.21:1. Average percent consumed for MBG003.6D CONTROL and MARKET LEADING CAT KIBBLE CONTROL is 72.28% and 27.72% respectively, for a consumption ratio of 2.61:1.

After statistical analysis, it is determined that MBG003.6D CONTROL is significantly preferred by a ratio of 2.61:1 versus MARKET LEADING CAT KIBBLE CONTROL when offered to this panel of cats.

The MBG003.6D is topically applied at 2.25% (percentage based on the weight of palatant per weight of dry kibble). The Edible Beef Tallow is applied at 7.5% (percentage based on the weight of fat per weight of dry kibble).

### EXAMPLE 2

The objective is to determine if one product's palatability is equal to or preferred to another when offered to a panel of cats. The two cat diets are identified as:

Diet A: MBG003.6D-GT

Diet B: MARKET LEADING CAT KIBBLE CONTROL

A panel of 21 group-housed cats is used for the trial. The panel receives the test diets in two large bowls labeled “A” and two large bowls labeled “B”. The bowls are randomly placed each day into four radio frequency monitored feeding stations at 4:45 p.m. and removed at 7:15 a.m. the next morning for a total feeding time of 14.5 hours.

The radio frequency system records First Choice, First Approached, and Meal Event Consumption Data for each member of the panel throughout the test period and transfers the information to a data collection computer. At the conclusion of the test, calculations and statistical analysis were performed by Preference Technology Inc., incorporated herein by reference.

Fresh, clean reverse osmosis water is available at all times. The procedure is carried out for 2 days. The following parameters are measured and recorded for each animal:

Amount of diet consumed daily

Diet first approached

Diet first tasted

Animal intake by hour and by day

Weight of the animal

Out of a total of 42 tastes, MARKET LEADING CAT KIBBLE CONTROL is first tasted 22 times and MB003.6D-GT is first tasted 20 times for a ratio of 1.1:1.

Average percent consumed for MB003.6D-GT and MARKET LEADING CAT KIBBLE CONTROL is 78.17% and 21.83% respectively, for a consumption ratio of 3.58:1.

After statistical analysis, it is determined that MB003.6D-GT is significantly preferred by a ratio of 3.58:1 versus MARKET LEADING CAT KIBBLE CONTROL when offered to this panel of cats.

The MBG003.6D-GT is topically applied at 2.25% (percentage based on the weight of palatant per weight of dry kibble). The Edible Beef Tallow is applied at 7.5% (percentage based on the weight of fat per weight of dry kibble).

### EXAMPLE 3

The objective is to determine if the addition of a standard green tea is equal to or preferred to the addition of an equal amount of another independently sourced green tea when offered to a panel of cats. The two cat diets are identified as:

### Diet A: MBG003.6D-RS+(CONTROL)

### Diet B: MBG003.6D-RS+1

A panel of 20 group-housed cats is used for the trial. The panel receives the test diets in two large bowls labeled “A” and two large bowls labeled “B”. The bowls are randomly placed each day into four radio frequency monitored feeding stations at 4:30 p.m. and removed at 7:00 a.m. the next morning for a total feeding time of 14.5 hours.

The radio frequency system records First Choice, First Approached, and Meal Event Consumption Data for each member of the panel throughout the test period and transfers the information to the data collection computer. At the conclusion of the test, calculations and statistical analysis were performed by Preference Technology Inc., incorporated herein by reference.

Fresh, clean reverse osmosis water is available at all times. The procedure is carried out for 2 days. The following parameters are measured and recorded for each animal:

Amount of diet consumed daily

Diet first approached

Diet first tasted

Animal intake by hour and by day

Weight of the animal

Out of a total of 39 tastes, MBG003.6D-RS+1 is first tasted 21 times and MBG003.6D-RS+(CONTROL) is tasted 18 times for a ratio of 1.17:1. Average percent consumed for MBG003.6D-RS+(CONTROL) and MBG003.6D-RS+1 is 51.33% and 48.67% respectively, for a consumption ratio of 1.05:1.

After statistical analysis, it is determined that there is not a significant difference in palatability between MBG003.6D-RS+(CONTROL) and MBG003.6D-RS+1 when offered to this panel of cats.

Both flavors are applied at 2% (percentage based on the weight of palatant per weight of dry kibble). Edible Beef Tallow is applied at 7.5% (percentage based on the weight of fat per weight of dry kibble).

### EXAMPLE 4

The objective is to determine if the addition of a standard green tea is equal to or preferred to the addition of an equal amount of another independently sourced green tea when offered to a panel of cats. The two cat diets are identified as:

Diet A: MBG003.6D-RS+(CONTROL)

Diet B: MBG003.6D-RS+2

A panel of 20 group-housed cats is used for the trial. The panel receives the test diets in two large bowls labeled “A” and two large bowls labeled “B”. The bowls are randomly placed each day into four radio frequency monitored feeding stations at 4:30 p.m. and removed at 7:00 a.m. the next morning for a total feeding time of 14.5 hours.

The radio frequency system records First Choice, First Approached, and Meal Event Consumption Data for each member of the panel throughout the test period and transfers the information to a data collection computer. At the conclusion of the test, calculations and statistical analysis were performed by Preference Technology Inc., incorporated herein by reference.

Fresh, clean reverse osmosis water is available at all times. The procedure is carried out for 2 days. The following parameters are measured and recorded for each animal:

Amount of diet consumed daily

Diet first approached

Diet first tasted

Animal intake by hour and by day

Weight of the animal

Out of a total of 40 tastes, MBG003.6D-RS+2 is first tasted 23 times and MBG003.6D-RS+(CONTROL) is first tasted 17 times for a ratio of 1.35:1. Average percent consumed for MBG003.6D-RS+(CONTROL) and MBG003.6D-RS+2 is 52.88% and 47.12% respectively, for a consumption ratio of 1.12:1.

After statistical analysis, it is determined that there is not a significant difference in palatability between MBG003.6D-RS+(CONTROL) and MBG003.6D-RS+2 when offered to this panel of cats.

Both dry flavors are applied at 2% (percentage based on the weight of palatant per weight of dry kibble). Edible Beef Tallow is applied at 7.5% (percentage based on the weight of fat per weight of dry kibble).

### EXAMPLE 5

The objective is to determine if the addition of a standard green tea is equal to or preferred to the addition of an equal amount of another independently sourced green tea. The two cat diets are identified as:

Diet A: MBG003.6D-RS+(CONTROL)

Diet B: MBG003.6D-RS+3

A panel of 20 group-housed cats is used for the trial. The panel receives the test diets in two large bowls labeled “A” and two large bowls labeled “B”. The bowls are randomly placed each day into four radio frequency monitored feeding stations at 4:30 p.m. and removed at 7:00 a.m. the next morning for a total feeding time of 14.5 hours.

The radio frequency system records First Choice, First Approached, and Meal Event Consumption Data for each member of the panel throughout the test period and transfers the information to a data collection computer. At the conclusion of the test, calculations and statistical analysis were performed by Preference Technology Inc., incorporated herein by reference.

Fresh, clean reverse osmosis water is available at all times. The procedure is carried out for 2 days. The following parameters are measured and recorded for each animal:

Amount of diet consumed daily

Diet first approached

Diet first tasted

Animal intake by hour and by day

Weight of the animal

Out of a total of 40 tastes, MBG003.6D-RS+(CONTROL) is first tasted 22 times and MBG003.6D-RS+3 is first tasted 18 times for a ratio of 1.22:1.

Average percent consumed for MBG003.6D-RS+(CONTROL) and MBG003.6D-RS+3 is 45.79% and 54.21% respectively, for a consumption ratio of 1:1.18.

After statistical analysis, it is determined that there is not a significant difference in palatability between MBG003.6D-RS+(CONTROL) and MBG003.6D-RS+3 when offered to this panel of cats.

Both flavors are topically applied at 2% (percentage based on the weight of palatant per weight of dry kibble). Edible Beef Tallow is applied at 7.5% (percentage based on the weight of fat per weight of dry kibble).

### EXAMPLE 6

The objective is to determine if a palatability system containing green tea is equal to or preferred to a similar palatability system devoid of green tea when offered to a panel of cats. The two cat diets are identified as:

Diet A: MBG003.6D-TG (2.25%)

Diet B: MBG003.6D-NTG (2.25%)

A panel of 20 group-housed cats is used for the trial. The panel receives the test diets in two large bowls labeled “A” and two large bowls labeled “B”. The bowls are randomly placed each day into four radio frequency monitored feeding stations at 4:30 p.m. and removed at 7:00 a.m. the next morning for a total feeding time of 14.5 hours.

The radio frequency system records First Choice, First Approached, and Meal Event Consumption Data for each member of the panel throughout the test period and transfers the information to a data collection computer. At the conclusion of the test, calculations and statistical analysis were performed by Preference Technology Inc., incorporated herein by reference.

Fresh, clean reverse osmosis water is available at all times. The procedure is carried out for 2 days. The following parameters are measured and recorded for each animal:

Amount of diet consumed daily

Diet first approached

Diet first tasted

Animal intake by hour and by day

Weight of the animal

Out of a total of 40 tastes, MBG003.6D-TG (2.25%) is first tasted 24 times and MBG003.6D-NTG (2.25%) is first tasted 16 times for a ratio of 1.5:1.

Average percent consumed for MBG003.6D-TG (2.25%) and MBG003.6D-NTG (2.25%) is 59.09% and 40.91% respectively, for a consumption ratio of 1.44:1.

After statistical analysis, it is determined that MBG003.6D-TG (2.25%) is significantly preferred by a ratio of 1.44:1 versus MBG003.6D-NTG (2.25%) when offered to this panel of cats.

Edible Beef Tallow is applied at 7.5% (percentage based on the weight of fat per weight of dry kibble).

### EXAMPLE 7

The objective is to determine if one product's palatability is equal to or preferred to another when offered to a panel of cats. The two cat diets are identified as:

Diet A: MBG003.6D-T

Diet B: MARKET LEADING CAT KIBBLE CONTROL

A panel of 21 group-housed cats is used for the trial. The panel receives the test diets in two large bowls labeled “A” and two large bowls labeled “B”. The bowls are randomly placed each day into four radio frequency monitored feeding stations at 4:45 p.m. and removed at 7:15 a.m. the next morning for a total feeding time of 14.5 hours.

The radio frequency system records First Choice, First Approached, and Meal Event Consumption Data for each member of the panel throughout the test period and transfers the information to the data collection computer. At the conclusion of the test, calculations and statistical analysis were performed by Preference Technology Inc., incorporated herein by reference.

Fresh, clean reverse osmosis water is available at all times. The procedure is carried out for 2 days. The following parameters are measured and recorded for each animal:

Amount of diet consumed daily

Diet first approached

Diet first tasted

Animal intake by hour and by day

Weight of the animal

Out of a total of 42 tastes, MBG003.6D-T and MARKET LEADING CAT KIBBLE CONTROL are both first tasted equally often. Average percent consumed for MBG003.6D-T and MARKET LEADING CAT KIBBLE CONTROL is 75.22% and 24.78% respectively, for a consumption ratio of 3.04:1.

After statistical analysis, it is determined that MBG003.6D-T is significantly preferred by a ratio of 3.04:1 versus MARKET LEADING CAT KIBBLE CONTROL when offered to this panel of cats.

MBG03.6D-T is topically applied at 2.25% (percentage based on the weight of palatant per weight of dry kibble). Edible Beef Tallow is applied at 7.5% (percentage based on the weight of fat per weight of dry kibble).

The description of the various embodiments and principles of the inventions has been presented for the purposes of illustration and description. It is not intended to be exhaustive or to limit the inventions to the precise forms disclosed. Many alternatives, modifications, and variations will be apparent to those skilled in the art. Moreover, although many inventive aspects have been presented, such aspects need not be utilized in combination, and various combinations of inventive aspects are possible in light of the various embodiments provided above. Accordingly, this description is intended to embrace all possible alternatives, modifications, combinations, and variations, and have been discussed or suggested herein, as well as all others that fall within the principles, spirit, and broad scope of the various inventions as defined by the claims.

We claim:

1. A palatability enhancer for a pet food, comprising:
a) brewers yeast;
b) hydrolyzed liver;
c) a phosphate; and
d) tea.

2. The palatability enhancer of claim 1, wherein the tea comprises at least one of green tea, black tea, white tea, oolong tea, and a portion of a Camellia sinensis plant.

3. The palatability enhancer of claim 2, wherein the tea comprises green tea.

4. The palatability enhancer of claim 3, wherein the green tea comprises at least one of ground green tea, crushed green tea, extruded green tea, distilled green tea, extracted green tea, fire-cured green tea, steam-cured green tea, extruded green tea, tumble roasted green tea, and processed green tea using direct or indirect heating sources.

5. The palatability enhancer of claim 1, wherein the tea comprises from about 0.01% to about 25% by weight of the palatability enhancer.

6. The palatability enhancer of claim 1, wherein the phosphate comprises at least one of trisodium pyrophosphate and disodium phosphate.

7. The palatability enhancer of claim 1, further comprising at least one of shrimp meal, tuna meal, seafood meal, citric acid, dried whey, hexametaphosphate, 1,5-octadien-3 one, and 1,5-octadien-3-ol.

8. A pet food comprising:
a) a basal food composition;
b) a palatability enhancer comprising an ingredient derived from tea.

9. The pet food of claim 8, wherein the tea comprises green tea.

10. The pet food of claim 9, wherein the green tea comprises at least one of ground green tea, crushed green tea, extruded green tea, distilled green tea, extracted green tea, fire-cured green tea, steam-cured green tea, extruded green tea, tumble roasted green tea, and processed green tea using direct or indirect heating sources.

11. The pet food of claim 9, wherein the palatability enhancer comprises green tea in an amount from about 0.01% to about 25.0%, by weight of the palatability enhancer.

12. The pet food of claim 8, wherein the palatability enhancer further comprises at least one of brewers yeast, hydrolyzed liver and a phosphate.

13. The pet food of claim 8, wherein the pet food has an aroma targeted to mimic a human table food.

14. The pet food of claim 9, wherein the human table food comprises steak, filet mignon, porterhouse, top sirloin, New York strip, stewed beef, rotisserie chicken, roast chicken, grilled chicken, fish, and the like.

15. A method of increasing the palatability of pet food comprising:
applying a palatability enhancer to said cat food, wherein the palatability enhancer comprises green tea in an amount from about 0.01% to about 25.0%, by weight of the palatability enhancer.

16. The method of claim 15, wherein the palatability enhancer further comprises at least one of brewers yeast, hydrolyzed liver and a phosphate.

17. The method of claim 15, wherein the pet food comprises at least one of a dry pet food, a high moisture content or canned pet food, an intermediate moisture content or semi-dry pet food and a pet treat.

18. The method of claim 15, wherein the green tea comprises at least one of ground green tea, crushed green tea, extruded green tea, distilled green tea, extracted green tea, fire-cured green tea, steam-cured green tea, extruded green tea, tumble roasted green tea, and processed green tea using direct or indirect heating sources.

19. The method of claim 15, further comprising application of an organic acid in sufficient quantity to deposit from about 0.01% to 10.0% by weight of the pet food.

20. The method of claim 15, further comprising application of a flavorant in sufficient quantity to deposit from about 0.01% to 10.0% by weight of the pet food.
